(19) United States
(12) Patent Application Publication
(10) Pub. No.: US 2025/0042371 A1
(43) Pub. Date: Feb. 6, 2025

(54) METHOD FOR DETERMINING THE HUMIDITY OF AN AGRICULTURAL SOIL

(71) Applicant: COMPAGNIE GENERALE DES ETABLISSEMENTS MICHELIN, Clermont-Ferrand (FR)

(72) Inventors: ANTOINE PATURLE, Clermont-Ferrand (FR); JEREMY VAYSSETTES, Clermont-Ferrand (FR); FRANCOIS PINET, Clermont-Ferrand (FR); ANNIE DUPARQUE, Estrees Mons (FR); MICKAEL LEFEBVRE, Entraigues (FR); DAMIEN MARTIN, Estrees Mons (FR); VINCENT TOMIS, Baralle (FR); OLIVIER SCHEURER, Nyons (FR); CAROLINA UGARTE, Beauvais (FR)

(21) Appl. No.: 18/720,027

(22) PCT Filed: Dec. 13, 2022
(86) PCT No.: PCT/EP2022/085652

§ 371 Date: Jun. 14, 2024

(30) Foreign Application Priority Data
Dec. 16, 2021 (FR) FR2113651

(51) Int. Cl. B60T 8/172; B60W 40/06

(52) U.S. Cl. CPC B60T 8/1725; B60W 40/06; B60W 2300/15; B60W 2530/20

(57) ABSTRACT

A method for determining the moisture of a ground on which a tire mounted on a vehicle is running, the tire being fitted with a sensor configured to acquire a measurement signal representative of the change in the curvature of the tire as it runs over a ground, comprises the following steps: acquiring a measurement signal representative of the change in the curvature of the tire while it is running; determining measurement data comprising (a) a first parameter (KSᵢₙ) representative of a rate at which the tire flattens on contact with the ground, and (b) a second parameter (KSₒᵤₜ) representative of a rate at which the tire regains its shape on becoming separated from the ground; and determining the moisture of the ground as a function of the first parameter (KSᵢₙ) and the second parameter (KSₒᵤₜ).

### FIELD OF THE INVENTION

The present invention relates to the determination of the water properties of a ground, in particular their spatial evolutions in real time. More specifically, the invention proposes determining a water condition of the ground by means of a measurement signal representative of the circumferential curvature of the tyre.

### TECHNOLOGICAL BACKGROUND

It has proven useful specifically to know, at all times, the water properties of a ground in order to interact with the driver or with the driving assistance systems, so as to inform them in real time since this water condition influences the running conditions, and possibly react to them. Notably, knowing a water condition of the ground makes it possible to adjust the use conditions of a vehicle. For example, in the presence of loose ground having a high moisture content, the inflation pressure of a tyre may be lowered in order to widen the area of the contact patch in which the tyre is in contact with the ground and to thus limit the compaction of the ground and the appearance of a rut after the agricultural implement has been run over it.

In combination with other parameters of the tyre, such as the load it carries, and of the ground, such as its mechanical resistance, knowing the water condition of the ground also makes it possible to estimate the compaction condition of the ground at a depth.

By coupling the water condition of the ground with synchronous geolocation data, it is possible to establish a map of the water condition of the ground of a plot of land, possibly enhanced by other characteristics of the ground. Such a map can prove useful in determining how to improve the ground in the plot of land, such as for example by installing drainage or specific modulated irrigation depending on the non-uniformity of the moisture in the ground or by modulated loosening of the ground at a depth depending on the estimated non-uniformity of the compaction of the ground.

Lastly, the ground, which in particular is agricultural ground, is complex and changes depending on the observation depth. It is characterized by physical variables such as its moisture, its texture and its structure. In general, the moisture of a ground, or its water condition, is defined specifically by the relative mass of water remaining in the ground once its “surface” portion has run off. This is referred to as moisture content by mass or gross weight, expressed as a percentage and designated H. However, the amount of water actually available to a plant, or capillary water, is less than the moisture content by mass since the plant must apply a suction force to take in this water, this being referred to as water potential, expressed in bar. Conventionally, the water potential of a plant is limited to 16 bar, above which the water is not available to the plant. Conversely, a ground at maximum water retention capacity will require a low suction force, of about 0.3 bar, from the plant: the ground is said to be at its “field capacity” of moisture. It is advisable to quantify the capillary water available at a given time or location of the field by calculating the ratio between the measured water content by weight H and its maximum value at the field capacity. HCC refers to this capillary water “normalized” in relation to the field capacity, also expressed as a percentage. Normalizing in relation to the field capacity makes it possible to define a moisture which is independent of the texture of the ground and representative of the water actually available to the plant. The texture of the ground corresponds to the ratio between its constituent clay, loam and sand. These three components are distinguished by their grain size. Thus, an HCC value of 99% means that the capillary water available to the plant corresponds to 99% of the field capacity, which is to say a value very close to the maximum possible value. However, this HCC value of 99% corresponds to a moisture content by weight H of about 40% for a ground with soil of low grain size and high retention of capillary water, such as a clay-based ground, but only to a moisture content by weight H of about 20% for a ground with soil of high grain size and low retention of capillary water, such as a sandy ground.

Lastly, the structure of the ground that corresponds to the three-dimensional arrangement of the material of the ground that it is possible to take note of at various levels, which is to say at different ground depth, is conventionally characterized by its apparent density, designated DA. This parameter can be affected by working of the ground, notably at levels close to the surface, which is to say of several tens of centimetres, but also by the passage of agricultural machines over the field in succession.

The combination of the moisture, the texture and the structure of the ground results in a complex material having specific mechanical properties. Just knowing the moisture content of a ground reveals information about the ground which then makes it possible to more easily derive the other physical parameters of the ground or to identify or evaluate the overall mechanical variables of the ground.

Patent application FR1860481A1 describes a determination of the firmness of the ground on the sole basis of a measurement of the change in the curvature of a tyre running over said ground. The firmness of the ground is linked to the rate at which the tyre flattens and to the length of the contact patch. The firmness of the ground corresponds to the analysis of the ground over a relatively great depth, this expressing the ability of the ground to bear loads.

However, this method does not make it possible to determine all the physical or mechanical features of the ground that can be of interest for particular applications. In particular, this method does not make it possible to determine the water condition of the ground, which is to say evaluate the amount of water present in the ground over a depth of several tens of centimetres beyond the surface water, for example which may potentially be absorbed by the plant.

The aim of the following subjects of the invention is to determine the water condition of the ground in real time in order to adapt the running conditions of the tyre as required but also adapt the preventative or curative actions to be carried out on the ground in order to optimize the potential of the ground.

### DESCRIPTION OF THE INVENTION

The invention concerns a method for determining the moisture of a ground on which a tyre mounted on a vehicle is running, said tyre being fitted with a sensor configured to acquire a measurement signal representative of the change in the curvature of the tyre as it runs over a ground, the method comprising the following steps:
acquiring, by way of the sensor, a measurement signal representative of the change in the curvature of the tyre while it is running,
determining, from the measurement signal, measurement data comprising:
   a) a first parameter representative of a rate, preferably angular rate, at which the tyre flattens on contact with the ground over the course of one revolution of the wheel bearing the tyre, and
   b) a second parameter representative of a rate, preferably angular rate, at which the tyre regains its shape on becoming separated from the ground over the course of one revolution of the wheel bearing the tyre,
determining the moisture of the ground as a function of the first parameter and the second parameter.

The method makes it possible to easily, precisely and reliably determine in real time, at the overall scale of the tyre, the water condition of a ground on which a tyre mounted on a vehicle is running, without taking the pressure or load or speed of the vehicle into consideration, from the single measurement signal representative of the change in the curvature of the tyre. Taking the angular rate into account makes it possible to automatically make the running speed of the tyre redundant.

In this instance, the first and second parameters are connected to local effects in the contact patch, which is to say the change in curvature on entering or leaving the contact patch, taking note of the rate of this change. These are not parameters at the overall scale of the contact patch, such as possibly the length of the contact patch. As these variables are local, their sensitivity is much greater than an overall variable at the scale of the contact patch. As a result, distinguished observation of these makes it possible to derive the water features of the ground on which the tyre is running, this not necessarily being possible, if not to say impossible, with an overall variable, such as the length of the contact patch, which naturally will average the effect over all of the contact patch.

This method is advantageously supplemented by the following features, considered alone or in any technically feasible combination thereof:
during running, over the course of one revolution of the wheel, the curvature of the tyre changes according to a cycle exhibiting:
   a part where there is no contact with the ground,
   a part where there is contact with the ground, wherein the first parameter is determined from part of the measurement signal corresponding to a transition in the curvature of the tyre between the part where there is no contact with the ground and the part where there is contact with the ground, and the second parameter is determined from part of the measurement signal corresponding to a transition in the curvature of the tyre between the part where there is contact with the ground and the part where there is no contact with the ground,
during running, over the course of one revolution of the wheel, the curvature of the tyre changes according to a cycle exhibiting:
   a part where there is no contact with the ground, characterized in the measurement signal by a stable curvature,
   a part where there is contact with the ground, characterized in the measurement signal by a contact curvature variation spike,
   a transition referred to as the coming-into-contact transition between the part where there is no contact with the ground and the part where there is contact with the ground, characterized in the measurement signal by a coming-into-contact curvature variation spike that is the opposite of the contact curvature variation spike,
a transition referred to as the coming-out-of-contact transition between the part where there is contact with the ground and the part where there is no contact with the ground, characterized in the measurement signal by a coming-out-of-contact curvature variation spike that is the opposite of the contact curvature variation spike, the first parameter being determined by a gradient between the coming-into-contact curvature variation spike and the contact curvature variation spike, the second parameter being determined by a gradient between the coming-into-contact curvature variation spike and the contact curvature variation spike,
having defined a third parameter representative of the variation in the recovery rate of the tyre, such as for example the difference or the ratio between the rate at which the tyre regains its shape and the rate at which the tyre flattens, the moisture of the ground is determined using a polynomial relationship connecting said moisture of the ground and the third parameter (ΔKS),
the polynomial relationship is of the order n, n being an integer of between 2 and 5, taking the following form:

$$F = {a}_{0} + {a}_{1} \times Δ KS + … + {a}_{n} \times {( Δ KS )}^{n}$$

where F is a moisture factor, ΔKS is the third parameter, and a₀ to aₙ are predetermined fixed coefficients,
the moisture of the ground is determined by calculating a moisture factor from the first parameter and the second parameter, and by comparing said moisture factor to thresholds delimiting moisture categories for the ground,
the moisture is included in the group comprising the moisture content by weight relative to the field capacity, the average moisture content by weight,
the moisture is defined over a ground depth X of less than 50 centimetres, preferentially less than 40 centimetres, potentially less than 30 centimetres or 20 centimetres,
a step of locating the vehicle during the step of acquiring the signal that provides an at least two-dimensional position of the vehicle.

The invention also relates to a map of the non-uniformity of the moisture of the ground of a surface on which a tyre mounted on a vehicle is running, said tyre being provided with a sensor configured to acquire a measurement signal representative of the change in the curvature of the tyre as it runs over the surface, the method comprising determining the moisture of the ground at least twice, corresponding to two at least two-dimensional positions of the vehicle that were obtained by the method according to the invention.

The invention also relates to a tyre comprising a sensor sensitive to the change in the curvature of the tyre and configured to generate a measurement signal representative of the change in the curvature of the tyre as it runs over a ground, comprising an active part and an electronic circuit board, the active part being configured to generate the measurement signal, the electronic circuit board being configured to determine measurement data comprising:
a) a first parameter representative of a rate, preferably angular rate, at which the tyre flattens on contact with the ground over the course of one revolution of the wheel bearing the tyre, and
b) a second parameter representative of a rate, preferably angular rate, at which the tyre regains its shape on becoming separated from the ground over the course of one revolution of the wheel bearing the tyre, the sensor being configured to transmit the measurement data to outside the tyre.

The invention also relates to a data processing unit configured to receive measurement data derived from a measurement signal representative of the change in the curvature of the tyre as it runs over a ground, said measurement data comprising:
a) a first parameter representative of a rate, preferably angular rate, at which the tyre flattens on contact with the ground over the course of one revolution of the wheel bearing the tyre, and
b) a second parameter representative of a rate, preferably angular rate, at which the tyre regains its shape on becoming separated from the ground during one revolution of the wheel bearing the tyre, the data processing unit being configured to determine the moisture of the ground as a function of the first parameter and the second parameter.

With preference, the data processing unit is configured to receive that at least two-dimensional position of the vehicle that is associated with the measurement data. The invention also relates to a vehicle comprising:
at least one tyre,
at least one sensor sensitive to the change in the curvature of the tyre and configured to generate a measurement signal representative of the change in the curvature of the tyre as it runs over a ground, and the sensor is preferably disposed inside the tyre,
a data processing unit configured to receive measurement data derived from the measurement signal representative of the change in the curvature of the tyre as it runs over a ground and to determine the moisture of the ground as a function of at least one of the measurement data, the measurement data comprising:
   a) a first parameter representative of a rate, preferably angular rate, at which the tyre flattens on contact with the ground over the course of one revolution of the wheel bearing the tyre, and
   b) a second parameter representative of a rate, preferably angular rate, at which the tyre regains its shape on becoming separated from the ground over the course of one revolution of the wheel bearing the tyre, the vehicle being configured to implement the method according to the invention.

The sensor preferably comprises an active part and an electronic circuit board, the active part being configured to generate the measurement signal, the electronic circuit board being configured to determine the measurement data, and wherein the data processing unit is disposed outside the tyre.

The invention also relates to a computer program product comprising program code instructions for executing the method according to the invention when said program is executed on a computer. The computer program product may take the form of a non-transient computer-readable medium that stores code instructions for executing the method according to the invention, when said non-transient computer-readable medium is read by a computer.

### BRIEF DESCRIPTION OF THE DRAWINGS

The invention will be better understood on reading the following description, which is given solely by way of non-limiting example and with reference to the appended figures, in which the same reference numbers denote identical parts throughout, and in which:

FIG. 1 schematically illustrates a tyre mounted on a rim of a vehicle;

FIG. 2 shows an example of a measurement signal read by a sensor sensitive to the curvature of the tyre as the tyre runs;

FIG. 3 shows a flowchart of the steps of the method for evaluating the moisture of a ground according to possible embodiments of the invention;

FIG. 4a and FIG. 4b each show an example of the statistical categorization and relationship between the two parameters derived from the measurement signal for a front tyre of a vehicle in various conditions of moisture of the ground;

FIG. 5 shows an example of a map of the non-uniformity of the moisture of the ground on a plot of land, the map being obtained from the measurement signal for one vehicle tyre.

### DETAILED DESCRIPTION OF EMBODIMENTS

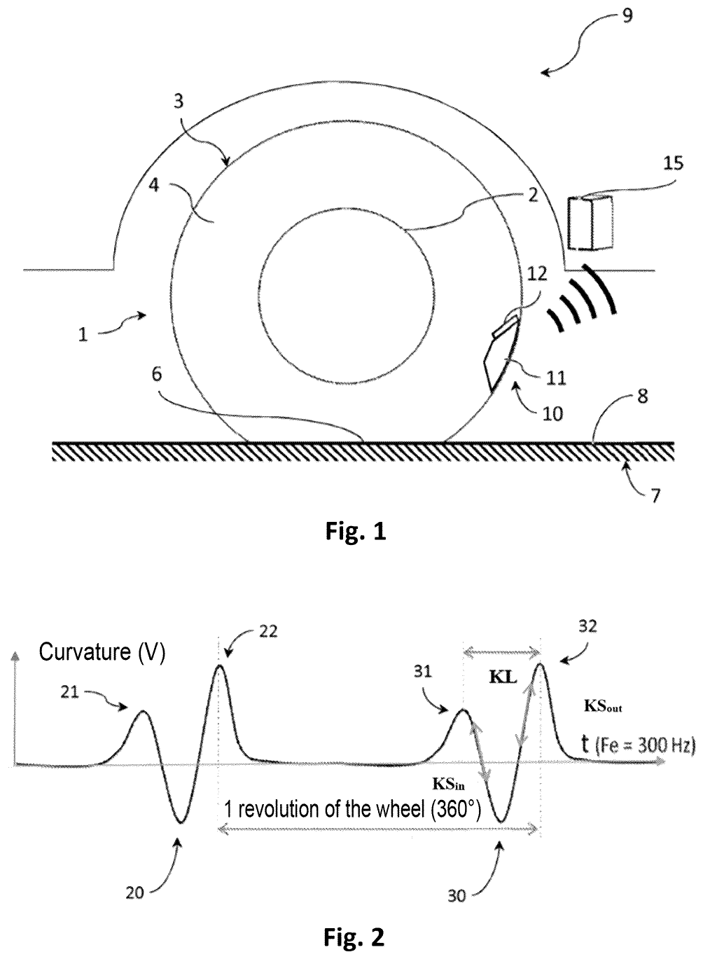

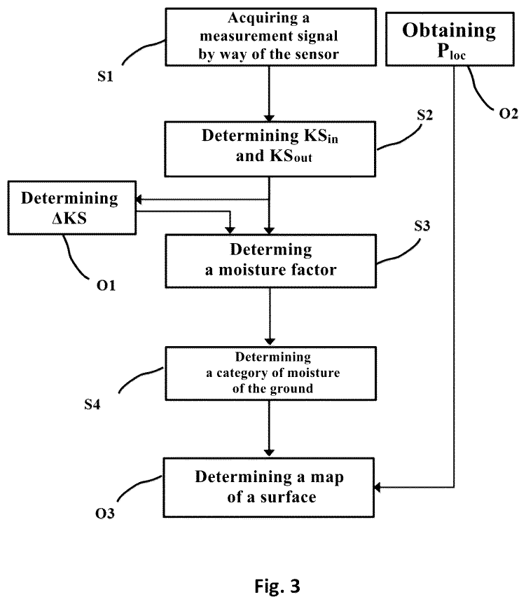

FIG. 1 illustrates a tyre 1 mounted on a rim 2. Such a tyre 1 comprises, on the one hand, a crown region 3, constituting a tread exhibiting tread patterns, and, on the other hand, sidewalls 4 ending in lower sidewall regions. The latter generally comprise a bead wire and a bead for mounting the tyre 1 on the rim 2. The rim 2 is itself connected to the vehicle 9 by an axle (not depicted). The tyre 1 thus forms the contact system providing the connection between the vehicle 9 and the ground 7.

Thus, what is meant by a tyre is a resilient solid designed to be mounted on the rim 2 of a wheel, generally in the form of a tyre band, to form the contact system providing the connection between the vehicle 9 and the ground 7, comprising a tread that undergoes a change in its circumferential radius of curvature when subjected to a load. The tyre 1 is typically made of elastomers (for example rubber) and possibly other textile and/or metallic materials. The tyre 1 may be airless, for example having flexible polyurethane spokes supporting the tread. However, as a preference, a tyre 1 comprises a flexible casing containing a pressurized gaseous interior, typically air. As this is the commonest form of tyre 1, the following description is given non-limitingly with reference to such a tyre 1 having an internal pressure of pressurized gas.

The tyre 1 is subjected to a force applied by the vehicle 9 via the axle and the rim 2 towards the ground 7. This force stems from the axle load, resulting from the weight of the vehicle 9. Because the rim 2 is non-deformable, this force, applied to the tyre 1, deforms the latter when the tyre 1 is in contact with the surface 8 of the ground 7: the part of the crown 3 below the rim 2 flattens, increasing the area of the contact patch 6 in which the tyre 1 is in contact with the ground, while the sidewalls 4 become distended. This deformation is all the more pronounced when the pressure inside the tyre is low. The nature of the ground 7 also has an influence on this deformation, and particularly the mechanical condition of this ground 7. Specifically, resistant ground deforms little if at all, whereas soft or loose ground deforms under the action of the tyre 1, so that the deformation of the tyre 1 is less as part of it is transferred to the ground 7.

The deformation of the tyre 1 results in a change to the circumferential curvature of the tyre 1, namely the curvature of the crown region 3. When the tyre 1 is running, this change to the curvature travels around the circumference of the tyre 1. For a given point on the tyre 1, the curvature will therefore vary periodically with each revolution of the wheel.

The tyre 1 is fitted with a sensor 10 configured to acquire a measurement signal representative of the change in the curvature of the tyre. This sensor 10 is situated inside the casing of the tyre 1. The sensor 10 is preferably situated against the crown region 3. The sensor 10 may be embedded in the structure of the casing of the tyre 1, or may be attached thereto, and for example held in place by an adhesive layer. The sensor 10 comprises an active part 11 secured to the casing of the tyre 1, so that the deformation of the tyre 1 leads to a corresponding deformation of the active part 11 of the sensor 10, which generates a measurement signal that is a function of the deformation of its active part 11. The measurement signal is therefore truly representative of the change in the curvature of the tyre.

As a preference, the sensor 10 is a piezoelectric sensor, which generates a voltage proportional to the variation in bending. More specifically, the sensor 10 may for example comprise an active part 11 made up of a piezoelectric layer between two conducting layers. It is also possible for the sensor 10 to be a resistive sensor, the impedance of which is proportional to the bending of the active part 11 of the sensor. It is also possible to use an accelerometer, although these are far more complex to use and require more processing of the signal. The sensor 10 may also be suited to measuring other parameters, particularly the pressure. The sensor 10 may be incorporated into another piece of electronic equipment installed inside the tyre 1, such as a pressure and/or temperature sensor of TMS (tyre monitoring system) type.

The sensor 10 also comprises an electronic circuit board 12 connected to the active part 11 of the sensor 10 and configured to receive the measurement signal coming from the active part 11. This electronic circuit board 12 comprises at least a processor and a memory, and is suited to processing data such as the measurement signal, in order to determine measurement data from the measurement signal, and to communicate these measurement data. As a preference, the sensor 10 is associated with a wireless transmitter, notably of the radiofrequency type, for example of the type using Bluetooth Low Energy technology, or of the low-power device type operating in the 433 MHz band (LPD 433) able to relay the measurement signal to an automated data processing unit, preferably disposed outside the tyre 1, in order to be processed. The wireless transmitter may form part of the sensor 10, for example as a component of the electronic circuit board 12, or may be separate from the sensor 10. It is thus possible, for example, to provide an antenna inside the tyre 1. In the case of wireless communication, an external receiver may receive the signals sent by the wireless communication means associated with the sensor 10, and relay them to the automated data processing unit.

Of course, the sensor 10 may comprise other elements involved in its correct operation, notably an electrical power supply module, for example consisting of a battery.

When the tyre 1 is running over the ground, the sensor 10 acquires (step S1) the measurement signal representative of the change in the circumferential curvature of the tyre. This measurement signal may be directly connected to the curvature (and therefore be a curvature measurement signal), and therefore monitor the change therein, or may be indirectly connected to the curvature. This is notably the case for a sensor 10 of which the active part 11 is a piezoelectric sensor, because the measurement signal then corresponds to the curvature after the signal has passed through a charge amplifier. It is this type of sensor that will be used in the examples which follow. The measurement signal, generated by the active part 11 of the sensor 10, is then processed by the electronic circuit board 12 to determine measurement data from the measurement signal. The purpose of processing the measurement signal is to extract the useful information in this signal, which information is then exploited later on in the method.

FIG. 2 shows a schematic example of a measurement signal read by a sensor 10 sensitive to the variation in curvature of the tyre when the tyre 1 is running. The measurement signal is represented here by its voltage (in V) and designated by curvature, as a function of the rotation of the wheel expressed in degrees.

During running, over the course of one revolution of the wheel, the curvature of the tyre changes according to a cycle exhibiting:
a part where there is no contact with the ground,
a part where there is contact with the ground.

The sequence illustrates two passes into the contact patch in which the tyre 1 is in contact with the ground, of that region in which the sensor 10 is located, which are separated by a part of the cycle where there is no contact with the ground. The part of the cycle where there is no contact with the ground is characterized by a stable curvature, which manifests itself in stability of the measurement signal. The part of the cycle where there is contact with the ground is characterized in the measurement signal by a contact curvature variation spike 20, 30. In FIG. 2, the contact curvature variation spikes 20, 30 are directed downwards. This is because the contact curvature variation spikes 20, 30 correspond to the flattening of the tyre 1 in the contact patch 6.

The curvature also exhibits a transition referred to as the coming-into-contact transition between the part where there is no contact with the ground and the part where there is contact with the ground, characterized in the measurement signal by a coming-into-contact curvature variation spike 21, 31 that is the opposite of the contact curvature variation spike 20, 30, namely in this instance directed upwards. The variation in curvature also exhibits a transition referred to as the coming-out-of-contact transition between the part where there is contact with the ground and the part where there is no contact with the ground, characterized in the measurement signal by a coming-out-of-contact curvature variation spike 22, 32 that is the opposite of the contact curvature variation spike, namely in this instance directed upwards. The coming-into-contact curvature variation spike 21, 31 and the coming-out-of-contact curvature variation spike 22, 32 correspond to the sudden variations in the radius of curvature of the tyre 1 on entering and leaving the contact patch.

Because the tyre is turning, this same cycle is repeated, with a measurement signal that is stable where there is no contact with the ground, followed by a coming-into-contact curvature variation spike 21, 31, a contact curvature variation spike 20, 30, a coming-out-of-contact curvature variation spike 22, 32, and lastly another stable measurement signal where there is no contact with the ground. This cycle corresponds to one revolution of the wheel, and therefore to 360°, which is shown in FIG. 2. For each cycle, the coming-out-of-contact curvature variation spike 22, 32 affords the major advantage of being a sharp spike and especially of being essentially independent of the conditions of the ground and of the tyre 1. Specifically, the coming-out-of-contact curvature variation spike 22, 32 corresponds to the change in curvature of the tyre 1 on leaving the contact patch, when the region of the tyre 1 in which the sensor 10 is located changes abruptly from the flat state characteristic of the part where there is contact with the ground to the curved state characteristic of the part where there is no contact with the ground. On loose ground, as the tyre 1 runs it compacts the ground beneath it, forming a rut, and therefore a rut bottom that is fairly firm and on which the tyre 1 rests as it leaves the contact patch. Furthermore, the forward progress of the vehicle 9 takes the strain essentially towards entering the contact patch. The tyre 1 on leaving the contact patch thus has a coming-out-of-contact behaviour, in terms of curvature, very similar to the way in which a tyre 1 behaves on a road.

It is thus easy to identify each cycle corresponding to a revolution of the wheel by identifying each coming-out-of-contact curvature variation spike 22, 32. It is also possible to identify the cycles using a dedicated device, such as a rev counter. On that basis, the data can be expressed as a function of the degree of angle in each cycle. That notably means that the cycles and their data can be compared independently of the speed of the vehicle 9. The method steps require just one cycle in order to be implemented, and can therefore be implemented on each cycle. However, in order to make the method more robust with respect to potential isolated unpredictable incidents (the presence of a stone for example), it is possible to use a combination of several measured cycles, for example using a moving average.

The mechanical condition of the ground influences the characteristics of the profile of the measurement signal. The invention therefore seeks to extract parameters from the measurement signal in order to deduce the mechanical condition of the ground therefrom. The method thus comprises determining (step S2), from the measurement signal, measurement data comprising at least one first parameter KSᵢₙ representative of an angular rate at which the tyre flattens on contact with the ground over the course of one revolution of the wheel bearing the tyre 1, and one second parameter KSₒᵤₜ representative of an angular rate at which the tyre regains its shape on becoming separated from the ground over the course of one revolution of the wheel bearing the tyre 1. The measurement data may comprise other parameters or values derived from the measurement signal.

The first parameter KSᵢₙ and the second parameter KSₒᵤₜ are determined from a part of the measurement signal corresponding to a transition of the curvature of the tyre between the part where there is no contact with the ground and the part where there is contact with the ground. More specifically, the first parameter KSᵢₙ is determined from a gradient between the coming-into-contact curvature variation spike 31 and the contact curvature variation spike 30. More specifically, the first parameter KSᵢₙ may correspond to the maximum variation (in terms of absolute value) in the curvature between the coming-into-contact curvature variation spike 31 and the contact curvature variation spike 30, which is to say may correspond to the maximum gradient. In the example, with the measurement signal being expressed in volts V as a function of angular degrees °, the first parameter KSᵢₙ may have the units V/°, which is to say may correspond to the first derivative of the curvature of the tyre 1.

The second parameter KSₒᵤₜ is determined from a gradient between the coming-out-of-contact curvature variation spike 32 and the contact curvature variation spike 30. More specifically, the second parameter KSₒᵤₜ may correspond to the maximum variation in the curvature between the coming-out-of-contact curvature variation spike 32 and the contact curvature variation spike 30, which is to say may correspond to the maximum gradient. In the example, with the measurement signal being expressed in volts V as a function of angular degrees °, the second parameter KSₒᵤₜ may have the units V/°, which is to say may correspond to the first derivative of the curvature of the tyre 1.

The parameters KSᵢₙ and KSₒᵤₜ may be approximated in several ways. For example, the parameters KS may correspond to the maximum (in the sense of absolute value) of the derivative of the measurement signal between the coming-into-contact curvature variation spike 31 or the coming-out-of-contact curvature variation spike 32 and the contact curvature variation spike 30, the derivative being estimated from the difference between two successive (or closely-spaced) measurement points, obviously taking their angular separation into consideration. As this is a falling gradient for KSᵢₙ in the example, the same will hold true for KSₒᵤₜ with a rising gradient, and this maximum in the sense of absolute value corresponds to a minimum of the derivative of the measurement signal between the coming-into-contact curvature variation spike 31 and the contact curvature variation spike 30. It is also possible, rather than looking for a derivative extremum, to choose fixed measurement points, such as for example those situated equidistantly from the peaks of the coming-into-contact curvature variation spike 31 and of the contact curvature variation spike 30, and calculate the derivative using these points. It is also possible to use the measurement points corresponding to a measurement signal value, such as for example the signal passing through “zero” in the case illustrated. It is also possible to use more complex approaches, such as for example the Savitzky-Golay algorithm. However, choosing a relatively low sampling frequency, typically less than or equal to 500 Hz, and preferably less than or equal to 400 Hz, such as the frequency of 300 Hz in the example, amounts to smoothing the measurement signal and makes it possible to select approaches, such as those set forth above, that are less demanding in terms of computation.

Considered individually, the parameters KS may depend on the load, the pressure and/or the speed. However, taking into account both the first parameter KSᵢₙ and the second parameter KSₒᵤₜ makes it possible to determine variables representative of the water condition of the ground, such as the moisture content by weight relative to the field capacity over a depth X quite close to the surface of the ground, HCC 0-X caused by the passage of the tyre 1, from just these parameters, without knowing the load, the pressure, the speed of the tyre 1 over the ground.

As a preference, it is the electronic circuit board 12 of the sensor 10 which, from the measurement signal, determines the measurement data comprising the first parameter KSᵢₙ and the second parameter KSₒᵤₜ. These measurement data are then transmitted by the sensor 10 to a data processing unit 15 which implements the next part of the method. This data processing unit 15 is preferably disposed outside the tyre 1, for example in the vehicle 9, but the processing unit 15 may also be remote from the vehicle 9, and the transmission of the data may then involve intermediate transmission means. The transmission of the measurement data between the sensor 10 and the data processing unit 15 is then performed wirelessly. The data processing unit 15 typically comprises a processor and a memory and is suited to receiving and processing the measurement data when implementing the next part of the method for determining the water condition of the ground.

It is possible to transmit the measurement signal to the processing unit 15 for implementing the next part of the method. However, determining the measurement data using the sensor 10 and transmitting these measurement data alone to the data processing unit 15 offers the advantage of reducing the amount of data transmitted between the sensor 10 and the data processing unit 15. As the transmission of data uses a great deal of energy, transmitting the measurement data rather than the measurement signal makes it possible to limit the electrical power consumption of the sensor 10, which has limited powering options inside the tyre 1.

It is also advantageous to not use the electronic circuit board 12 of the sensor 10 to implement the next part of the method but rather to use the data processing unit 15 to process the measurement data. This limits the calculations performed by the electronic circuit board 12 of the sensor 10, making it possible to save on power and memory for the electronic circuit board 12. In addition, it is easier to modify the ways in which the next part of the method is implemented on a readily accessible data processing unit 15 rather than on the sensor 10 which is inside the tyre 1.

Once the processing unit 15 has received the measurement data, the processing unit 15 can determine the mechanical property of the ground as a function of the first parameter KSᵢₙ and of the second parameter KSᵢₙ which are present in the measurement data and vary as a function of the mechanical resistance close to the surface of the ground, as shown below.

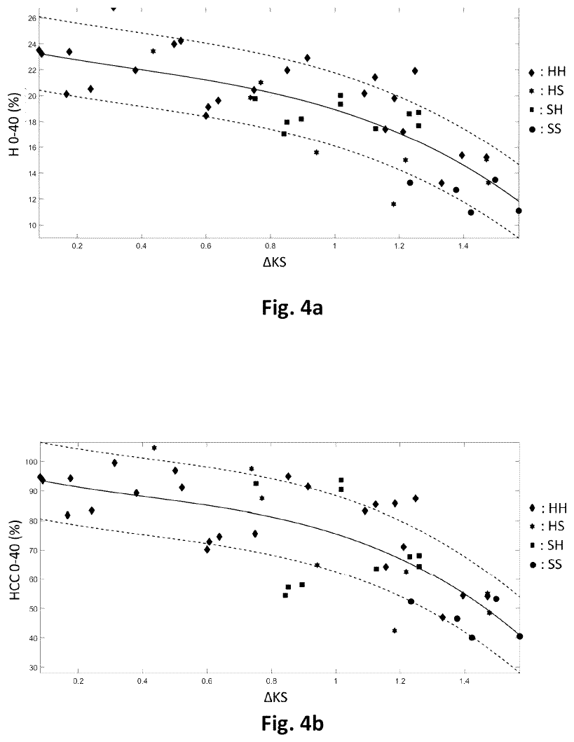

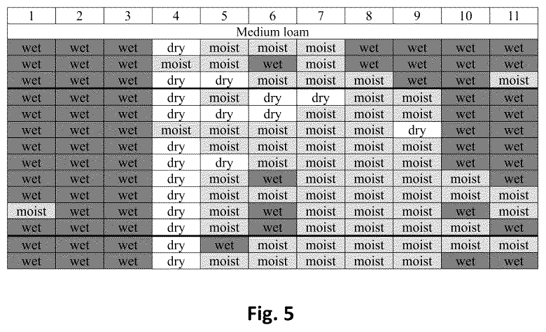

FIG. 4a and FIG. 4b are illustrations of the determination of the water condition of the ground which is overall at the scale of the tyre.

In these examples, the measurement data are derived from a measurement signal acquired by a piezoelectric sensor 10 disposed in a front tyre of an offset trailer pulled by an agricultural tractor while said tractor is passing over a ground. This makes it possible to place measuring instruments on the trailer that are necessary to determine the pressure and the load applied to the tyre in stable fashion. The offset of the trailer, in particular of the measurement tyre in relation to the tyres of the tractor, ensures that the ground is not packed down by the passage of the tractor but indeed only by the passage of the measurement tyre.

The tractor runs on a ground exhibiting three different ground moisture conditions:
a ground of the wet type, denoted HH, which is to say moist on the surface and at a depth corresponding to wintry conditions for the countries in the northern hemisphere;
a ground of the moist type denoted HS, which is to say moist on the surface but dry at a depth corresponding to autumnal conditions for the same countries as above;
a ground of the dry type, denoted SH or SS, which is to say dry on the surface corresponding to springlike conditions (wet at a depth) or summery conditions (dry at a depth) for the countries cited above.

The water condition of the ground was characterized by the analysis of ground test specimens in the form of core samples at various depths X. The moisture content by weight or mass is evaluated by comparing the weight in the natural state of the core sample with its dry weight which was obtained after the core sample of ground was dried. The core samples of the ground were taken synchronously on the scale of a day with measurements taken on a tyre over a path adjacent to the measurement path of the tyre having the same physical ground features, which is to say the same physical variables in terms of texture, structure and moisture.

The results of FIG. 4a and FIG. 4b compile the data obtained for three types of ground having different textures (sandy loam, clay loam and loam). For each of these textures, the grounds were prepared according to three different structural conditions:

A packed-down or compacted condition, designated “W0”, corresponds to the condition of the ground left after a harvest, as a result of which the ground is packed down by an inflated and loaded tyre passing over it many times without any working of the ground after these passages.

A disturbed or soft ground condition made by harrowing the packed-down ground over a depth of 10 or 30 centimetres, designated “W10” and “W30”, respectively.

Lastly, measurements using the sensor 10 on the tyre were taken under different load and pressure conditions applied to the tyre so as to be representative of the use of an agricultural tyre in a field. The measurements were taken for various running speeds below a maximum speed of 20 km/h.

FIG. 4a shows a quadratic relationship between the moisture content by weight of the ground over a depth of 40 centimetres, denoted H 0-40, and the variation in the recovery rate of the tyre ΔKS. The dashed curved lines represent the 90% confidence band. In this case, the variation in the recovery rate of the tyre ΔKS is obtained, such as the difference between the rate at which the tyre regains its shape KSₒᵤₜ and the absolute value of the rate at which the tyre flattens KSᵢₙ. This relationship continues to apply irrespective of the ground type and in particular its structure, its texture and its moisture.

It is possible to define categories of moisture or water condition of the ground particularly in three different levels, thereby making it possible to distinguish the water condition of the ground using a laboratory-type characterization over a certain depth X. In the case of FIG. 4a, the moisture content by weight H 0-40 corresponds to the average of the moisture measurements of the core samples taken at depths of 10, 20, 30 and 40 centimetres of the various grounds on the various paths of the plots of land. However, it is entirely possible to perform these moisture measurements over shallower ground depths but the results are generally not as good.

By way of non-limiting illustration, since they are highly dependent on the texture of the ground, the following categories can be used:

TABLE 1

| | | | |
|---|---|---|---|
| H 0-40 (%) | <=15 | 15-20 | >20 |
| Moisture categories | dry | moist | wet |
| ΔKS | >=1.2 | 1.2-0.6 | <0.6 |

A surprising level of correlation was identified between this laboratory measurement and the variation in the recovery rate of the tyre ΔKS which was obtained using the measurement from the sensor 10 mounted on the tyre. It was thus easy to determine the category of moisture of the ground over a depth of 40 centimetres close to the surface before the tyre passes over it solely by measuring the parameters KSᵢₙ and KSₒᵤₜ, irrespective of the texture, the moisture and the structure of the ground and the conditions of use of the tyre, i.e. the inflation pressure, the load applied and the running speed.

Thus, using F to denote the moisture factor of the ground, in this case moisture content by weight H over a depth of 40 centimetres, associated with the variation in the recovery rate of the tyre, and f to denote a function corresponding to the quadratic relationship and concerning the parameter ΔKS, it is possible to write the following:

$$F = f ( Δ KS ) \qquad [ Math 1 ]$$

More specifically, the quadratic relationship may take the following form:

$$F = {a}_{0} + {a}_{1} * Δ KS + {a}_{2} * {( Δ KS )}^{2} + … + {a}_{n} * {( Δ KS )}^{n} \qquad [ Math 2 ]$$

where F is the moisture factor of the ground over a depth of 40 centimetres, ΔKS is the variation in the recovery rate of the tyre, such as being the difference between the rate at which the tyre regains its shape KSₒᵤₜ and the rate at which the tyre flattens KSᵢₙ, and a₀ to aₙ are predetermined fixed real coefficients.

The fixed coefficients a₀ to aₙ are preferably chosen to maximize the discrimination between moisture categories of the ground. It is possible for example to use a one-dimensional discriminant analysis. This discriminant analysis seeks to maximize the separations between the centres of gravity of each of the moisture categories of the ground, while at the same time minimizing the spread within the category.

By way of non-limiting illustration, the moisture content by weight factor of the ground over a depth of 40 centimetres (H 0-40) can be determined as follows:

$$H 0 - 40 ( \% ) = 23.63 - 4.98 \times Δ KS + 3.54 \times Δ {KS}^{2} - 3.28 \times Δ {KS}^{3} \qquad [ Math 3 ]$$

FIG. 4b shows a quadratic relationship between the moisture relative to the field capacity of the ground over a depth of 40 centimetres, denoted HCC 0-40, and the variation in the recovery rate of the tyre ΔKS. The dashed curved lines represent the 90% confidence band. In this case, the variation in the recovery rate of the tyre ΔKS is obtained, such as the difference between the absolute value of the rate at which the tyre flattens KSᵢₙ and the rate at which the tyre regains its shape KSₒᵤₜ. This relationship continues to apply irrespective of the ground type and in particular its structure, its texture and its moisture or the conditions of use of the tyre.

A surprising level of correlation was identified between this laboratory measurement and the variation in the recovery rate of the tyre ΔKS which was obtained using the measurement from the sensor 10 mounted on the tyre. It was thus easy to determine the moisture relative to the field capacity of the ground over a depth of 40 centimetres close to the surface solely by measuring the parameters KSᵢₙ and KSₒᵤₜ, irrespective of the texture, the moisture and the structure of the ground and the conditions of use of the tyre, i.e. the inflation pressure, the load applied and the running speed.

Thus, using F to denote the moisture factor of the ground, in this case moisture relative to the field capacity HCC over a depth of 40 centimetres, associated with the variation in the recovery rate of the tyre, and f to denote a function corresponding to the quadratic relationship and concerning the parameter ΔKS, it is possible to write the following:

$$F = f ( Δ KS ) \qquad [ Math 1 ]$$

More specifically, the quadratic relationship may take the following form:

$$F = {a}_{0} + {a}_{1} * Δ KS + {a}_{2} * {( Δ KS )}^{2} + … + {a}_{n} * {( Δ KS )}^{n} \qquad [ Math 2 ]$$

where F is the moisture factor of the ground over a depth of 40 centimetres, ΔKS is the variation in the recovery rate of the tyre, such as being the difference between the rate at which the tyre regains its shape KSₒᵤₜ and the rate at which the tyre flattens KSᵢₙ, and a₀ to aₙ are predetermined fixed real coefficients.

The fixed coefficients a₀ to aₙ are preferably chosen to maximize the discrimination between moisture categories of the ground. It is possible for example to use a one-dimensional discriminant analysis. This discriminant analysis seeks to maximize the separations between the centres of gravity of each of the moisture categories of the ground, while at the same time minimizing the spread within the category.

By way of non-limiting illustration, the moisture factor relative to the field capacity of the ground over a depth of 40 centimetres (HCC 0-40) can be determined as follows:

$$HCC 0 - 40 ( \% ) = 90.3 + 8.5 \times Δ KS - 24.07 \times Δ {KS}^{2} \qquad [ Math 4 ]$$

FIG. 5 is a map of the categories of moisture content by weight H of the ground evaluated on the basis of measurements taken during the passage of the measurement tyre over the ground at the scale of an agricultural plot of land. This plot of land having a loamy texture was initially highly irrigated over its entire width using an irrigation ramp in order to obtain a water condition of the “HH” type, i.e. wintery water conditions.

The moisture content by weight of the ground H is evaluated by measuring the rate at which the tyre flattens, KSᵢₙ, and the rate at which the tyre regains its shape, KSₒᵤₜ, for each revolution of the wheel bearing the tyre. Subsequently, the variation in the recovery rate of the tyre ΔKS is evaluated by establishing the difference between the rate at which the tyre regains its shape KSₒᵤₜ and the rate at which the tyre flattens KSᵢₙ.

The columns of the map represent the longitudinal furrows made by the passage of the tyre equipped with the measuring sensor 10 over the agricultural plot of land under a consistent running condition of the tyre. However, from one furrow to the next, the conditions of use of the tyre can change with an increase in the load applied to the tyre or with a modification of the inflation pressure of the tyre, for example. In this case all the plot of land is considered to have the same physical properties in terms of texture and initial structure. However, some furrows have been subjected to specific preparation work that potentially makes the structure of this furrow different from the other furrows. Some furrows in the same plot of land have a structure of the W0, or W10 or W30 type.

For the same furrow, which is to say the same column for a given plot of land, the various lines correspond to linear units of the furrow corresponding to one revolution of the wheel bearing the measurement tyre, i.e. a distance of approximately 5 metres. For each revolution of the wheel, the rates at which the tyre flattens KSᵢₙ and regains its shape KSₒᵤₜ are measured. A variation in the recovery rate ΔKS of the tyre is deduced from these values. The average moisture content by weight of the ground H is then evaluated over a depth of 40 centimetres for each revolution of the wheel.

The water condition of the linear unit of each furrow and the water condition of the furrow is then classified according to the three classifications defined above, which is to say wet, moist and dry, to obtain the map in FIG. 5.

A good correlation was observed between the water condition imposed on each furrow with the water condition obtained by the method in terms of statistical classifications, irrespective of the physical properties of the ground analysed. In particular, a strong disparity was observed in the centre of the plot of land, which was much dryer than at its edges. This disparity was attributed partially to problems with the nozzles of the irrigation ramp and to the non-uniform surface texture of the plot of land.

Such a map therefore shows clear agricultural potential by analysing the potential water non-uniformity of the ground of an agricultural plot of land, thereby making it possible to adapt the conditions of use of the tyre a priori to each region of the plot of land in question but also to adapt the irrigation of the plot of land to the spatial non-uniformity of the water condition of the plot of land.

1.-14. (canceled)

15. A method for determining a moisture of a ground on which a tire mounted on a vehicle is running, the tire being fitted with a sensor configured to acquire a measurement signal representative of a change in a curvature of the tire as it runs over the ground, the method comprising the following steps:
acquiring, using the sensor, a measurement signal representative of the change in the curvature of the tire while it is running;
determining, from the measurement signal, measurement data comprising:
(a) a first parameter KSᵢₙ representative of a rate at which the tire flattens on contact with the ground over a course of one revolution of a wheel bearing the tire, and
(b) a second parameter KSₒᵤₜ representative of a rate at which the tire regains shape on becoming separated from the ground over the course of one revolution of the wheel bearing the tire; and
determining the mechanical property of the ground as a function of the first parameter KSᵢₙ and/or the second parameter KSₒᵤₜ.

16. The method according to claim 15, wherein, during running, over the course of one revolution of the wheel, the curvature of the tire changes according to a cycle exhibiting:
a part where there is no contact with the ground, and
a part where there is contact with the ground, wherein the first parameter KSᵢₙ is determined from a part of the measurement signal corresponding to a transition in the curvature of the tire between the part where there is no contact with the ground and the part where there is contact with the ground, and the second parameter KSₒᵤₜ is determined from a part of the measurement signal corresponding to a transition in the curvature of the tire between the part where there is contact with the ground and the part where there is no contact with the ground.

17. The method according to claim 15, wherein, during running, over the course of one revolution of the wheel, the curvature of the tire changes according to a cycle exhibiting:
a part where there is no contact with the ground, characterized in the measurement signal by a stable curvature,
a part where there is contact with the ground, characterized in the measurement signal by a contact curvature variation spike,
a coming-into-contact transition between the part where there is no contact with the ground and the part where there is contact with the ground, characterized in the measurement signal by a coming-into-contact curvature variation spike that is opposite of the contact curvature variation spike, and
a coming-out-of-contact transition between the part where there is contact with the ground and the part where there is no contact with the ground, characterized in the measurement signal by a coming-out-of-contact curvature variation spike that is opposite of the contact curvature variation spike, the first parameter KSᵢₙ being determined by a gradient between the coming-into-contact curvature variation spike and the contact curvature variation spike, and the second parameter KSₒᵤₜ being determined by a gradient between the coming-into-contact curvature variation spike and the contact curvature variation spike.

18. The method according to claim 15, wherein, having defined a third parameter ΔKS representative of a variation in a recovery rate of the tire, the moisture of the ground is determined using a polynomial relationship connecting the moisture of the ground and the third parameter ΔKS.

19. The method according to claim 18, wherein the polynomial relationship is of the order n, n being an integer of between 2 and 5, taking the following form:
$$F = {a}_{0} + {a}_{1} \times Δ KS + … + {a}_{n} \times {( Δ KS )}^{n}$$
where F is a moisture factor, ΔKS is the third parameter, and a₀ to aₙ are predetermined fixed coefficients.

20. The method according to claim 15, wherein the moisture of the ground is determined by calculating a moisture factor F from the first parameter KSᵢₙ and the second parameter KSₒᵤₜ, and by comparing the moisture factor to thresholds delimiting moisture categories for the ground.

21. The method according to claim 15, wherein the moisture of the ground is included in the group comprising a moisture content by weight relative to the field capacity HCC and an average moisture content by weight H.

22. The method according to claim 15, wherein the moisture is defined over a ground depth X of less than 50 centimeters.

23. The method according to claim 15, further comprising a step of locating the vehicle during the step of acquiring the signal that provides an at least two-dimensional position Ploc of the vehicle.

24. A tire comprising a sensor sensitive to a change in a curvature of the tire and configured to generate a measurement signal representative of the change in the curvature of the tire as it runs over a ground, comprising an active part and an electronic circuit board, the active part being configured to generate the measurement signal, the electronic circuit board being configured to determine measurement data comprising:
(a) a first parameter KSᵢₙ representative of a rate at which the tire flattens on contact with the ground over a course of one revolution of a wheel bearing the tire, and
(b) a second parameter KSₒᵤₜ representative of a rate at which the tire regains shape on becoming separated from the ground over the course of one revolution of the wheel bearing the tire, the sensor being configured to transmit the measurement data to outside the tire.

25. A data processing unit configured to receive measurement data derived from a measurement signal representative of a change in a curvature of a tire as it runs over a ground, the measurement data comprising:
(a) a first parameter KSᵢₙ representative of a rate at which the tire flattens on contact with the ground over a course of one revolution of a wheel bearing the tire, and
(b) a second parameter KSₒᵤₜ representative of a rate at which the tire regains shape on becoming separated from the ground over the course of one revolution of the wheel bearing the tire,
the data processing unit being configured to determine the moisture of the ground as a function of the first parameter KSᵢₙ and the second parameter KSₒᵤₜ.

26. A vehicle comprising:
at least one tire;
at least one sensor sensitive to a change in a curvature of the tire and configured to generate a measurement signal representative of the change in the curvature of the tire as it runs over a ground;
a data processing unit configured to receive measurement data derived from the measurement signal representative of the change in the curvature of the tire as it runs over a ground and to determine the moisture of the ground as a function of at least one of the measurement data, the measurement data comprising:
(a) a first parameter KSᵢₙ representative of a rate at which the tire flattens on contact with the ground over a course of one revolution of the wheel bearing the tire, and
(b) a second parameter KSₒᵤₜ representative of a rate at which the tire regains shape on becoming separated from the ground over the course of one revolution of the wheel bearing the tire, the vehicle being configured to implement the method according to claim 15.

27. The vehicle according to claim 26, wherein the at least one sensor is disposed inside the tire.

28. The vehicle according to claim 27, wherein the at least one sensor comprises an active part and an electronic circuit board, the active part being configured to generate the measurement signal, the electronic circuit board being configured to determine the measurement data, and
wherein the data processing unit is disposed outside the tire.
